(19) United States
(12) Patent Application Publication
(10) Pub. No.: US 2011/0139432 A1
(43) Pub. Date: Jun. 16, 2011

(54) SYSTEM, METHOD AND ASSEMBLY FOR STEAM DISTRIBUTION ALONG A WELLBORE

(75) Inventor: Donald Bryan Freeman, Humble, TX (US)

(73) Assignee: Chevron U.S.A. Inc., San Ramon, CA (US)

(21) Appl. No.: 12/967,981

(22) Filed: Dec. 14, 2010

Related U.S. Application Data
(60) Provisional application No. 61/286,067, filed on Dec. 14, 2009.

(51) Int. Cl. E21B 43/24; F16K 17/38

(52) U.S. Cl. 166/57; 137/468

(57) ABSTRACT

Methods and apparatus for enhanced and improved viscous oil recovery are disclosed. A horizontal well is drilled through the viscous oil formation. A liner includes temperature actuated valves for delivering steam more uniformly along the heel and toe portions of the liner. The temperature actuated valves include an actuation mechanism that actuates from an open position to a closed position to control the flow of the steam therethrough. The actuation mechanism actuates to the closed position when it exceeds a predetermined temperature. Heat from the steam mobilizes and lowers the viscosity of the heavy crude wherein the crude is then produced to the surface via conventional lift arrangements.

### CROSS-REFERENCE TO A RELATED APPLICATION

The present application for patent claims the benefit of U.S. Provisional Application bearing Ser. No. 61/286,067, filed on Dec. 14, 2009, which is incorporated by reference in its entirety.

### TECHNICAL FIELD

This invention relates to oil field production apparatus and techniques, and more particularly, to such apparatus and techniques for use in the production of heavy oil or viscous crude oil.

### BACKGROUND

It has been known to produce viscous crude oils in reservoirs by drilling vertical wells into the producing zone and then injecting steam into the producing zone to increase the mobility and reduce the viscosity of the viscous crude. This steam injection has been done in several different ways. In one technique, wells in the reservoir can be cyclically steamed using a process called cyclic steam stimulation (CSS). In this process, steam is injected down a vertical well into the producing zone. The steam is allowed to “soak” in the reservoir for a relatively short period of time to heat the crude oils, thus reducing its viscosity and increasing its mobility. The well is then placed back in production for a relatively longer period of time to extract the heated less viscous crude oil. This cycle is typically repeated until the production becomes unprofitable.

Another technique which has been used to produce viscous crude reservoirs is to drill vertical wells in a geometrical pattern into the producing zone, such as in a 5-spot or 9-spot pattern. In these geometrical patterns, the wells are placed within the reservoir field, typically in a symmetric fashion, and are designated as either an injection well or a production well based on its position in the pattern. Steam is continuously injected into the producing zone via the injection wells to heat the viscous crude oil and drive it to neighboring vertical producing wells in the geometrical array.

In the initial development of a reservoir of viscous crude these described methods have worked well. Over time however, the steam tends to congregate in the upper portion of the producing zone. This, of course, may cause less heating of the viscous crude in the lower portion of the producing zone. The heavy crude saturated lower portion of the producing zone is not depleted as the high viscosity of the crude prevents its migration to the well bores of the producing wells. Thus large quantities of potentially producible crude oil can otherwise become not recoverable.

It is known in the art that horizontally-oriented, or horizontal wells can be utilized to help production from the portions of the producing zone, especially the lower portion discussed above, which are typically not depleted after injecting steam with vertical wells. It is desirous in these assemblies to deliver uniformly distributed steam to the producing zone along the entire length of the horizontal section of the well.

Currently available steam injection systems used for disbursement of steam in the reservoir typically include slotted liners or pipes having a series of orifices or holes. A well known problem with such assemblies is that the steam injected into the reservoir tends to be disbursed at the “toe” and “heel” portions (or the furthest and nearest portions) of the injection zone and not uniformly distributed throughout the formation. Different orifice or hole sizes have been used to control the disbursement of the steam, but such arrangements still do not provide a reliable and efficient method for optimizing the distribution of steam within the subterranean reservoir.

### SUMMARY

According to an aspect of the present invention, a valve assembly is disclosed for controlling fluid flow. The valve assembly includes a valve casing, a valve seat, and an actuation mechanism. The valve casing defines a first opening, a second opening, and a passageway extending therebetween. The valve seat is located adjacent the first opening. The actuation mechanism is carried within the valve casing, and includes an actuation chamber, an actuation member, and a sealing element such as a valve ball. The actuation chamber has a rigid chamber body defining a chamber volume therewithin. The actuation member is carried within the actuation chamber. The sealing element engages the valve seat to seal the first opening of the valve casing when in a closed position. The sealing element disengages the valve seat when in an open position. The actuation member communicates with the sealing element to actuate the sealing element to the closed position when the chamber volume exceeds a predetermined temperature, such as between about 200 to about 400 Degrees Celsius.

In one embodiment, the actuation member is a bimetallic material. In another embodiment, the actuation member is a smart memory metal.

In one or more embodiments, the actuation mechanism includes a positioning member between the valve casing and the rigid chamber body of the actuation chamber to provide clearance for the passageway.

In one or more embodiments, the actuation mechanism has an initial spring coefficient that actuates the sealing element to the closed position until a predetermined pressure acts on the sealing element.

In one or more embodiments, the actuation member actuates the sealing element to the open position when the chamber volume is reduced below the predetermined temperature.

According to another aspect of the present invention, a well assembly is disclosed for injecting steam into a subterranean reservoir. The well assembly includes a wellbore in fluid communication with a producing zone of the subterranean reservoir. The wellbore has a substantially vertical section and a substantially horizontal section extending from a lower portion of the substantially vertical section. The substantially horizontal section defines a heel portion located adjacent the vertical section and a toe portion located distally therefrom. A plurality of valve assemblies is axially located on the substantially horizontal section to disburse steam to the producing zone of the subterranean reservoir. Each valve assembly includes an actuation mechanism that actuates from an open position to a closed position to control the flow of the steam therethrough. The actuation mechanism actuates to the closed position when it exceeds a predetermined temperature, such as between about 200 to about 400 Degrees Celsius.

In one or more embodiments, the valve assembly includes a valve casing defining a first opening, a second opening, and a passageway extending therebetween. The actuation mechanism is carried within the valve casing and includes an actuation chamber, an actuation member, and a sealing element such as a valve ball. The actuation chamber has a rigid chamber body defining a chamber volume therewithin. The actuation member is carried within the actuation chamber. The sealing element engages a valve seat adjacent the first opening to seal the first opening of the valve casing when in the closed position. The sealing element disengages the valve seat when in the open position. The actuation member communicates with the sealing element to actuate the sealing element to the closed position when the chamber volume exceeds the predetermined temperature.

In one embodiment, the plurality of valve assemblies is located on the internal surface of the substantially horizontal section. In another embodiment, the plurality of valve assemblies is located on the external surface of the substantially horizontal section.

In one or more embodiments, each valve assembly is received within a recess within the substantially horizontal section.

In one embodiment, the actuation mechanism includes a bimetallic actuation member. In another embodiment, the actuation member is a smart memory metal.

In one or more embodiments, the actuation mechanism has an initial spring coefficient such that the actuation mechanism is actuated to the closed position until the substantially horizontal section exceeds a predetermined pressure.

In one or more embodiments, the actuation member actuates to the open position when reduced below the predetermined temperature.

### BRIEF DESCRIPTION OF THE DRAWINGS

FIG. 1 is a schematic, sectional view of a prior art steam delivery in a horizontal well in the field of hydrocarbon production.

FIG. 2 is a schematic, sectional view of a prior art steam delivery in a horizontal well in the field of hydrocarbon production.

FIG. 3 is a schematic, sectional view of a steam distribution assembly according to an embodiment of the present invention for use in the field of hydrocarbon production.

FIG. 4 is a schematic, sectional view of a valve in an open position for the steam distribution assembly of FIG. 3.

FIG. 5 is a schematic, sectional view of the valve in FIG. 4 in a closed position.

### DETAILED DESCRIPTION

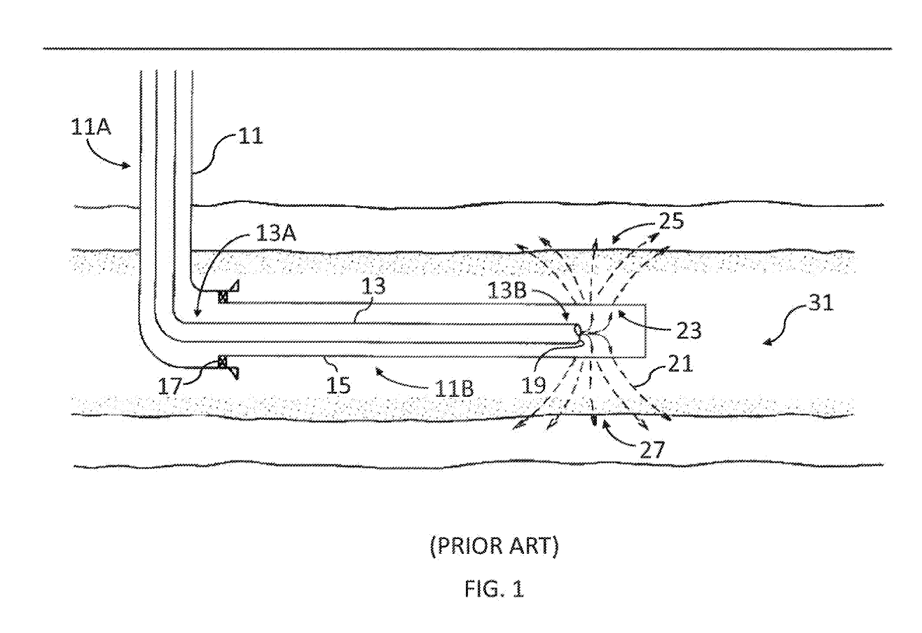

Referring initially to prior art FIG. 1, a cross sectional view shows a wellbore 11 having vertical section 11A and horizontal section 11B. Wellbore 11 provides a flow path between the well surface and producing sand or reservoir 31. Tubing string 13 and slotted liner 15 are also shown in FIG. 1. The horizontal section 11B of tubing string 13 includes a heel portion 13A and an opposite toe portion 13B. Slotted liner 15 is a completion device lining horizontal section 11B of wellbore 11 and is typically isolated by a lead seal 17 from vertical section 11A of wellbore 11. Live steam is supplied via tubing string 13 and exits from toe portion 13B at end 19. The steam flow is as indicated by arrows 21. Direct impingement of live steam onto slotted liner 15 at the area numbered 23 can potentially cause erosion and collapse of the liner 15, which is an undesirable condition. Also, using this technique the steams heat is concentrated near toe portion 13B in areas 25 and 27 of reservoir 31 rather than along the length of slotted liner 15.

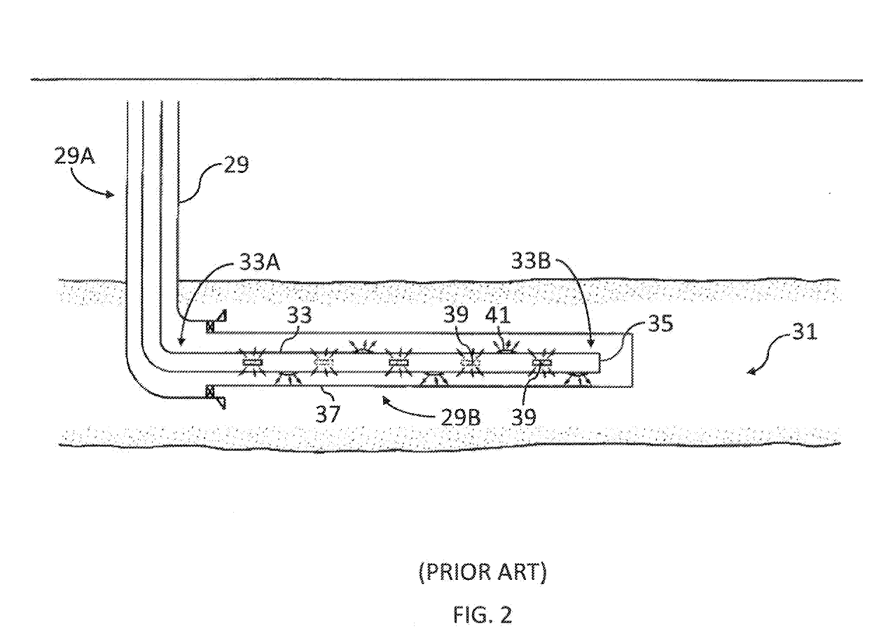

Referring now to prior art FIG. 2, wellbore 29 has vertical section 29A, which goes to the surface, and horizontal section 29B that penetrates a long horizontal section of producing sand or reservoir 31. Slotted liner 37 lines horizontal section 29B of wellbore 29. Tubing string 33 is run in from the surface and, on the lower end thereof is plugged off by plug 35. The horizontal section 298 of tubing string 33 includes a heel portion 33A and an opposite toe portion 33B. The length of tubing string 33, prior to the plug 35, is provided with spaced apart drilled holes 39 along its entire horizontal section between heel portion 33A and toe portion 33B. Each drilled hole 39 is covered with a sacrificial impingement strap 41. Sacrificial impingement straps 41 are constructed of a carbon steel material and may be ceramic coated if desired. Sacrificial impingement straps 41 are welded to tubing string 33 with an offset above each drilled hole 39.

A steam generator source (not shown) is located at the surface and provides an input of steam into tubing string 33. The steam travels down tubing string 33 to its lower horizontal section 29B where it exits via drilled holes 39.

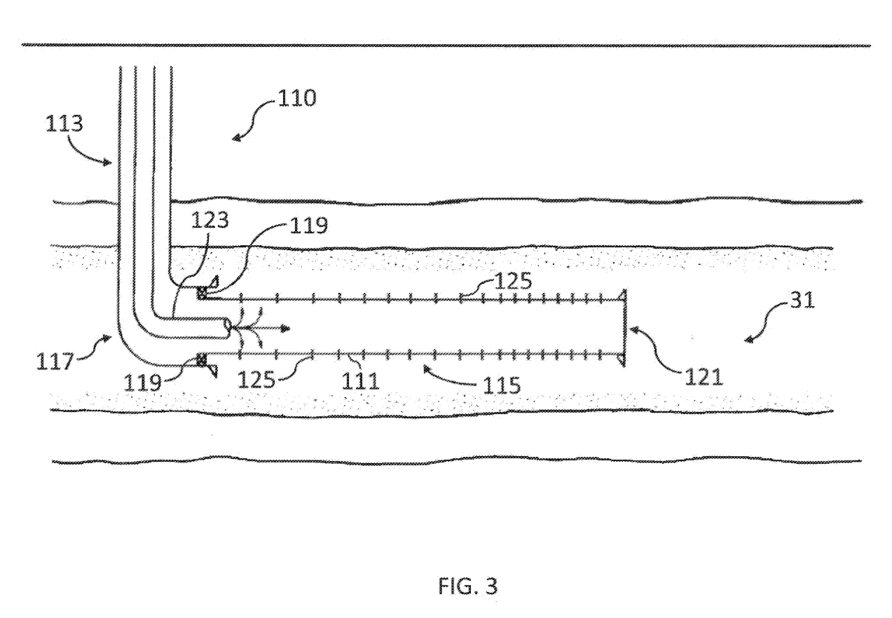

Referring to FIG. 3, wellbore 110 is in fluid communication with a producing zone of subterranean reservoir 31. Wellbore 110 includes substantially vertical section 113 and substantially horizontal section 115 extending from a lower portion of substantially vertical section 113. According to an embodiment of the present invention, horizontal section 115 includes liner 111, which extends from vertical section 113 and through which steam is delivered into reservoir 31. Horizontal section 115 includes heel portion 117, adjacent seals 119, and toe portion 121 distally located away from seals 119 and vertical section 113. Liner 111 receives steam from string of tubing 123 for delivery into reservoir 31. A plurality of valves 125 are positioned intermittently between heel and toe portions 117, 121. The axial distance between valves 125 can be adjusted for optimum, uniform or targeted delivery of steam into reservoir 31.

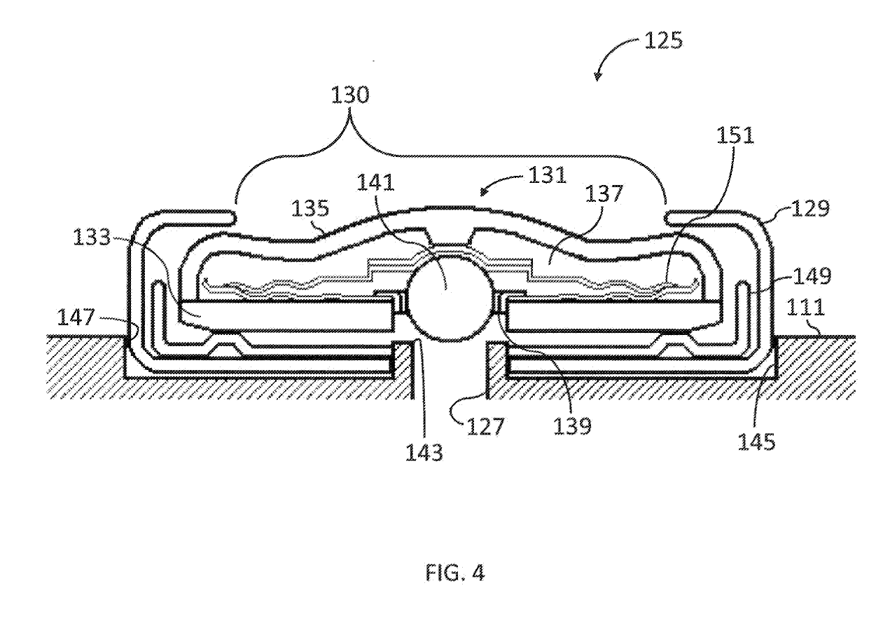

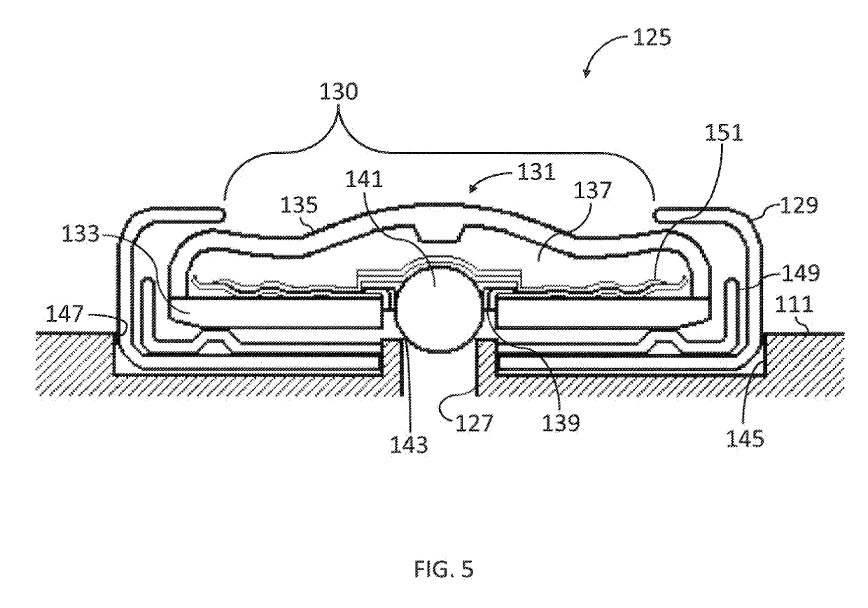

Referring to FIGS. 4 and 5, valve 125 is shown in the open position (FIG. 4) and the closed position (FIG. 5). Valve 125 is positioned to communicate steam from within liner 111 through orifice 127 to the producing zone of reservoir 31. Valve 125 can be positioned on either the internal or external surface of liner 111. While valve 125 is attached to liner 111 in FIG. 3, one skilled in the art will appreciate that tubing 123 can extend throughout horizontal section 115 and valve 125 could alternatively be attached thereto.

Valve 125 includes a valve casing 129 defining the outer portion of valve 125 through which steam flows. Valve casing 129 initially extends radially outward from the axis of orifice 127 a predetermined distance to define the diameter of valve 125. Valve casing 129 then extends parallel with the axis of orifice 127 and back radially inward to define the boundaries of valve 125. Valve casing 129 extends radially inward a lesser distance than extending radially outward to define an opening 130 through which steam communicates.

Valve 125 includes actuation assembly 131 carried within valve casing 129. Actuation assembly 131 comprises valve base 133 and valve housing 135, which define valve actuation chamber 137. Guide member 139, which is connected to valve base 133, guides valve ball 141 between open and closed positions when actuation assembly 131 actuates. Valve ball 141 engages and disengages from valve seat 143 formed in the portion of orifice 127 adjacent valve 125.

Liner 111 can include recess 145 for receiving valve casing 129. Recess 145 is preferably formed radially outward of orifice 127 a predetermined distance to thereby form valve connector 147. Valve connector 147 extends along the axis of orifice 127 for engagement with valve 125. Those skilled in the art will readily appreciated there are several ways for valve 125 to connect with valve connector 147. For example, valve connector 147 can be threaded for threadedly engaging valve casing 129. Alternatively, valve casing 129 can have a predetermined clearance over valve connector 147 to form an interference fit, or such that when liner 111 is heated an interference fit is formed.

Positioning member 149 is preferably positioned between valve casing 129 and valve base 133 of actuation assembly 131 so that there is clearance for communicating steam when valve ball 141 is in the open position (FIG. 4). Valve ball 141 engages valve seat 143 when in the closed position (FIG. 5) such that steam communication is ceased or impinged.

Actuation assembly 131 also includes actuation member 151 that engages valve ball 141, and actuates valve ball 141 between open and closed positions. Actuation assembly 131 actuates between the open and closed positions of FIGS. 4 and 5, respectively, when the temperature exceeds or drops below a predetermined value. Such can be achieved with such technologies as bimetallic materials, smart memory metals/alloys, or a combination thereof. U.S. patent application Ser. No. 12/262,750 provides examples of such technologies and is hereby incorporated by reference.

In one embodiment, the actuation mechanism actuates to the closed position when it exceeds 200 Degrees Celsius, and opens when it drops below 200 Degrees Celsius. In another embodiment, the actuation mechanism actuates to the closed position when it exceeds 400 Degrees Celsius, and opens when it drops below 400 Degrees Celsius. In another embodiment, the actuation mechanism is designed to actuate between about 200 to about 400 Degrees Celsius. Typically the actuation point is determined based on the well characteristics, reservoir characteristics, and the amount of heat needed to mobilize the viscous crude within the reservoir.

Actuation assembly 131 can be set with an initial spring coefficient such that valve ball 141 is actuated to the closed position until liner 111 is pressurized by the steam being injected. Then actuation assembly 131 and valve ball 141 remain open until actuation assembly 131 exceeds the predetermined temperature necessary to actuate valve ball 141 to the closed position. Alternatively, a spring (not shown) could be positioned between valve ball 141 and valve housing 135 for biasing valve ball 141 to the closed position prior to pressurizing liner 111 with steam.

In operation, string of tubing 123 delivers steam to liner 111. Steam travels from heel 117 to toe portion 121. Portions of steam are communicated through open valves 125 and orifices 127 into reservoir 31 while traveling from heel portion 117 to toe portion 121. In the preferred embodiment, valves 125 are biased to the closed position prior to liner 111 being pressurized by the delivery of steam from string of tubing 123. Once steam is delivered to liner 111 and the pressure within liner 111 is increased above a predetermined amount, valves 125 open such that steam is delivered to reservoir 31.

Depending upon whether valves 125 are positioned on the internal or external surface of liner 111, steam communicates into valve through either opening 130 (internal positioning) or between valve seat 143 of orifice 127 and valve ball 141 (external positioning). Steam flows between the interior of valve casing 129 and the exterior of actuation assembly 131 while communicating between opening 130 and the clearance between valve seat 143 and valve ball 141 for delivery into reservoir 31. Steam also communicates between valve ball 141 and valve actuation base 133 such that steam collects within chamber 137. Actuation member 151 is exposed to the steam within chamber 137. As steam collects within chamber 137, the temperature of actuation member 151 increases.

When the temperature of chamber 137 and actuation member 151 exceed the predetermined value, actuation member 151 actuates valve ball 141 from the open position shown in FIG. 4 to the closed position shown in FIG. 5. Valve ball 141 sealingly engages valve seat 143 so that steam no longer communicates from liner 111 to reservoir 31. While valve ball 141 is closed, steam also does not communicate into chamber 137, thereby allowing actuation member 151 to cool. When actuation member 151 cools below the predetermined temperature, actuation member 151 actuates valve ball 141 back to the open position shown in FIG. 4. This opening and closing cycle continues to help ensure uniform delivery of steam from liner 111 into reservoir 31.

While the invention has been shown in only some of its forms, it should be apparent to those skilled in the art that it is not so limited, but susceptible to various changes without departing from the scope of the invention.

What is claimed is:

1. A valve assembly to control the flow of fluids therethrough, the valve assembly comprising:
a valve casing defining a first opening, a second opening, and a passageway extending therebetween;
a valve seat located adjacent the first opening; and
an actuation mechanism carried within the valve casing, the actuation mechanism comprising:
an actuation chamber having a rigid chamber body defining a chamber volume therewithin;
a sealing element that engages the valve seat to seal the first opening of the valve casing when in a closed position and disengages the valve seat when in an open position; and
an actuation member carried within the actuation chamber, the actuation member being in communication with the sealing element to actuate the sealing element to the closed position when a temperature within the chamber volume exceeds a predetermined temperature.

2. The valve assembly of claim 1, wherein the actuation mechanism further comprises a positioning member between the valve casing and the rigid chamber body of the actuation chamber to provide clearance for the passageway.

3. The valve assembly of claim 1, wherein the chamber volume is in fluid communication with the first opening when the sealing element is in the open position such that the chamber volume receives fluid.

4. The valve assembly of claim 3, wherein the actuation member is adapted to actuate the sealing element to the closed position when the fluid in the chamber volume exceeds the predetermined temperature.

5. The valve assembly of claim 1, wherein the actuation member is a bimetallic material.

6. The valve assembly of claim 1, wherein the actuation member is a smart memory metal.

7. The valve assembly of claim 1, wherein the predetermined temperature is between about 200 to about 400 Degrees Celsius.

8. The valve assembly of claim 1, wherein the actuation mechanism has an initial spring coefficient that actuates the sealing element to the closed position until a predetermined pressure acts on the sealing element.

9. The valve assembly of claim 1, wherein the actuation member further actuates the sealing element to the open position when the temperature within the chamber volume is reduced below the predetermined temperature.

10. The valve assembly of claim 1, wherein the sealing element is a valve ball.

11. A valve assembly to control the flow of fluids therethrough, the valve assembly comprising:
a valve casing defining a first opening, a second opening, and a passageway extending therebetween;
a valve seat located adjacent the first opening; and
an actuation mechanism carried within the valve casing, the actuation mechanism comprising:
a sealing element that engages the valve seat to seal the first opening of the valve casing when in a closed position and disengages the valve seat when in an open position;
an actuation chamber having a rigid chamber body defining a chamber volume therewithin, the chamber volume being in fluid communication with the first opening when the sealing element is in the open position such that the chamber volume receives fluid; and
an actuation member carried within the actuation chamber, the actuation member being in communication with the sealing element to actuate the sealing element to the closed position when the fluid within the chamber volume exceeds a predetermined temperature.

12. The valve assembly of claim 11, wherein the actuation mechanism further comprises a positioning member between the valve casing and the rigid chamber body of the actuation chamber to provide clearance for the passageway.

13. The valve assembly of claim 11, wherein the actuation member is a bimetallic material.

14. The valve assembly of claim 11, wherein the actuation mechanism has an initial spring coefficient that actuates the sealing element to the closed position until a predetermined pressure acts on the sealing element.

15. The valve assembly of claim 11, wherein the actuation member further actuates the sealing element to the open position when the fluid within the chamber volume is reduced below the predetermined temperature.

16. A well assembly for injecting steam into a subterranean reservoir, the well assembly comprising:
a wellbore in fluid communication with a producing zone of a subterranean reservoir, the wellbore comprising a substantially vertical section and a substantially horizontal section extending from a lower portion of the substantially vertical section, the substantially horizontal section defining at a heel portion located adjacent the vertical section and a toe portion located distally therefrom; and
a plurality of valve assemblies axially located on the substantially horizontal section to disburse steam therewithin to the producing zone of the subterranean reservoir, each valve assembly comprising an actuation mechanism that actuates from an open position to a closed position to control the flow of the steam therethrough, the actuation mechanism actuating to the closed position when reaching a predetermined temperature.

17. The well assembly of claim 16, wherein:
the valve assembly further comprises a valve casing defining a first opening, a second opening, and a passageway extending therebetween; and
the actuation mechanism is carried within the valve casing and further comprises:
an actuation chamber having a rigid chamber body defining a chamber volume therewithin;
a sealing element that engages a valve seat adjacent the first opening to seal the first opening of the valve casing when in the closed position and disengages the valve seat when in the open position; and
an actuation member carried within the actuation chamber, the actuation member in communication with the sealing element to actuate the sealing element to the closed position when the chamber volume exceeds the predetermined temperature.

18. The well assembly of claim 16, wherein the predetermined temperature is between about 200 to about 400 Degrees Celsius.

19. The well assembly of claim 16, wherein the actuation mechanism has an initial spring coefficient such that the actuation mechanism is actuated to the closed position until the substantially horizontal section exceeds a predetermined pressure.

20. The well assembly of claim 16, wherein the actuation member further actuates to the open position when reduced below the predetermined temperature.
